(19) United States
(12) Patent Application Publication
(10) Pub. No.: US 2009/0060338 A1
(43) Pub. Date: Mar. 5, 2009

(54) Method of indexing Chinese characters

(76) Inventors: Por-Sen Jaw, Bel Air, MD (US); Yin-Ping Chao, Sung-Shan (TW)

Correspondence Address: H. JAY SPIEGEL - H. JAY SPIEGEL & ASSOCIATES, P.O. BOX 11, MOUNT VERNON, VA, 22121, US

(21) Appl. No.: 11/896,523

(22) Filed: Sep. 4, 2007

(51) Int. Cl. G06K 9/18

(52) U.S. Cl. 382/185

(57) ABSTRACT

In practicing the present invention, in analyzing a Chinese character, a 3×3 square grid of 9 boxes is superimposed over the character. The character is analyzed based upon the shape of the stroke that is at the lowest elevation within the lower right-hand corner. A Table is consulted consisting of a plurality of elements including horizontal strokes, and the element most closely resembling the corresponding portion of the character is chosen. The user then consults a Root Table where characters all having in common the same part of the character immediately on top are displayed. From examination of the Root Table, the user narrows down the identity of the character to a smaller group. The pages to which the user is directed are carefully reviewed and the entire character may be found in a Form Block including pertinent information concerning the character. When the entire character is found, reference is made to a page in a dictionary where the same character may be found along with its definition and examples of proper use.

### BACKGROUND OF THE INVENTION

The present invention relates to a method of indexing Chinese characters. The Chinese language began to evolve over 4,000 years ago. At present, it encompasses over 40,000 different characters. In order to read a typical Chinese newspaper, the average person has to know about 3,000 characters. In secondary schools, the number of characters taught is typically about 5,000. These statistics make it clear that learning of the Chinese language is often a lifelong experience.

Given the need to continually study the Chinese language as more and more characters are added to one's repertoire, there has been a longstanding need for a way to organize a Chinese language dictionary so that Chinese characters may easily be located therein along with their definitions, either in Chinese or a diverse language.

Chinese language dictionaries are arranged in numerous ways including phonetically, by rhyming as well as, in some cases, by common characteristics of the characters themselves. In the latter case, however, no effective way has been devised to provide a logical order in which characters may be arranged.

Each Chinese character may be described as having an element family from which an element may be discerned. There are seven element families defined by strokes included in a character. Those five major element families include horizontal strokes, vertical strokes, slash strokes, dots and hooks. Hooks may be described in three sub-families including straight hooks, slanted hooks and bent hooks. Thus, the seven element families actually include the four described as horizontal strokes, vertical strokes, slash strokes and dots, and three variations of hooks.

Chinese characters may also be expanded into approximately twenty-four elements that are made up of a variety of the characteristics of the element families. It would be advantageous if Chinese characters could be characterized and defined in terms of element families, elements, and roots in such a way that those characteristics correlate to pages in a dictionary where definitions of characters, either in Chinese or another language, may be found. It is with these thoughts in mind that the present invention was developed.

### SUMMARY OF THE INVENTION

The present invention relates to a method of indexing Chinese characters. The present invention includes the following interrelated objects, aspects and features:

(1) In practicing the teachings of the present invention, in analyzing a Chinese character, a 3×3 square grid of 9 boxes is superimposed over the character. The character is analyzed based upon the stroke that is at the lowest elevation within the lower right-hand corner thereof. Applicant has found that this technique is effective for all but about 10 characters.

(2) In defining the lower right-hand corner of the character, one practicing the inventive method looks at three of the nine boxes, namely, the box at the lower right-hand corner as well as the box just to the left of the lower right-hand corner, and the box just above the lower right-hand corner. These boxes are numbered by the numbers 1, 2 and 3, with the number 2 designating the box at the lower right-hand corner, the number 1 designating the box to the left, and the number 3 designating the box above.

(3) Within the three identified boxes, the lowermost stroke is identified and the shape of the stroke designates the element family. For example, the lowermost stroke in the lower right-hand corner might be a horizontal stroke. A Table is consulted which consists of a plurality of elements including horizontal strokes, and the element most closely resembling the corresponding portion of the character is chosen.

(4) In the Table described above, corresponding numbers and letters are provided that lead the user to a Root Table where characters all having in common the same part of the character immediately on top are displayed. From examination of the Root Table, the user narrows down the identity of the character to a smaller group located on a number of pages in the index to which the user is directed. The pages to which the user is directed are carefully reviewed and the entire character may be found.

(5) When the entire character is found, it is printed within a Form Block that includes a great deal of information including reference to a page in a dictionary where the same character may be found along with its definition and examples of proper use. The Form Block may also include information as to the relationship between traditional and simplified Chinese characters, the China'sPinyin, the pronunciation, the type of originated character for the simplified character, and the precise coding for every individual character/form.

(6) The dictionary may be one that provides definitions in Chinese or in any other non-Chinese language such as English, French, Spanish, etc. As is well known, different Chinese dictionaries utilize diverse hierarchies that determine the order in which Chinese characters are listed. In English language dictionaries, words are always arranged in alphabetical order. In the Chinese language, no such rigid order is standard and differing publishers utilize differing ways of arranging the order of characters.

(7) The inventive index may be correlated with standard dictionaries now sold or, if desired, may be incorporated in a newly devised dictionary having a more logical order in accordance with elements and element families. If desired, the inventive index may be published with a dictionary or as a separate volume along with the dictionary as a second volume or, again, the index may be devised with page numbers correlating to the pages of an existing published dictionary.

(8) The present invention will assist any user trying to achieve the college level of Chinese language knowledge in a much shorter period of time than is now possible in conjunction with dictionaries currently on the market. In accordance with the teachings of the present invention, characters with similar shapes or pronunciations are grouped together which results in reduction of errors that might occur when writing in Chinese.

Accordingly, it is a first object of the present invention to provide a method of indexing Chinese characters.

It is a further object of the present invention to provide such a method in which Chinese characters are first characterized by identifying the shape of the stroke located at the lower right-hand corner thereof.

It is a still further object of the present invention to provide such a method in which identification of the shape of a stroke at the lower right-hand corner of a character facilitates characterization of the element family of the character.

It is a still further object of the present invention to provide such a method in which from the identification of the element family, an element of the character may be identified.

It is a still further object of the present invention to provide such a method in which identification of the element of the character permits one to refer to a Root Table where numerous characters having the same element in common are displayed.

It is a yet further object of the present invention to provide such a method in which from choice of the numerated root most resembling that which is included in a particular character, the user of the method through identification of a designated number for a root may be directed to the character located in a Form Block and then, from information displayed in the Form Block, to a particular page in a dictionary where the character and its definition may be discerned.

It is a still further object of the present invention to provide such a method in which the dictionary in question may translate the Chinese character into another language or merely define the character in the Chinese language.

These and other objects, aspects and features of the present invention will be better understood from the following detailed description of the preferred embodiment when read in conjunction with the appended drawing figures.

### BRIEF DESCRIPTION OF THE DRAWINGS

FIG. 1 shows a flowchart providing a general overview of the searching method of the present invention as explained in Appendix pages A1-A26.

FIG. 2 shows a further flowchart more specific to a particular example of a Chinese character.

FIG. 3a shows a chart of seven element families.

FIG. 3b provides explanation of a Form Block.

FIG. 4 shows a Table of elements.

FIG. 5a shows a flowchart for searching for the Chinese character corresponding to the word “Spring.”

FIG. 5b shows a Root Table pertinent to the Chinese character of FIG. 5a.

FIG. 5c shows a pertinent page from an index in accordance with the teachings of the present invention where the Chinese character for “Spring” may be found.

FIG. 6a shows a flowchart for searching for the Chinese character corresponding to the word “Rich” or “Wealthy.”

FIG. 6b shows a Root Table pertinent to the Chinese character of FIG. 6a.

FIG. 6c shows a pertinent page from an index in accordance with the teachings of the present invention where the Chinese character for “Rich” or “Wealthy” may be found.

FIG. 7a shows a flowchart for searching for the Chinese character corresponding to the word “Give” or “Deliver.”

FIG. 7b shows a Root Table pertinent to the Chinese character of FIG. 7a.

FIG. 7c shows a pertinent page from an index in accordance with the teachings of the present invention where the Chinese character for “Give” or “Deliver” may be found.

FIG. 8a shows a flowchart for searching for the Chinese character corresponding to the word “Typhoon.”

FIG. 8b shows a Root Table pertinent to the Chinese character of FIG. 8a.

FIG. 8c shows a pertinent page from an index in accordance with the teachings of the present invention where the Chinese character for “Typhoon” may be found.

FIG. 9a shows a flowchart for searching for the Chinese character corresponding to the word “Happiness.”

FIG. 9b shows a Root Table pertinent to the Chinese character of FIG. 9a.

FIG. 9c shows a pertinent page from an index in accordance with the teachings of the present invention where the Chinese character for “Happiness” may be found.

FIG. 10a shows a flowchart for searching for the Chinese character corresponding to the word “Zhao clan.”

FIG. 10b shows a Root Table pertinent to the Chinese character of FIG. 10a.

FIG. 10c shows a pertinent page from an index in accordance with the teachings of the present invention where the Chinese character for “Zhao clan” may be found.

### SPECIFIC DESCRIPTION OF THE PREFERRED EMBODIMENT

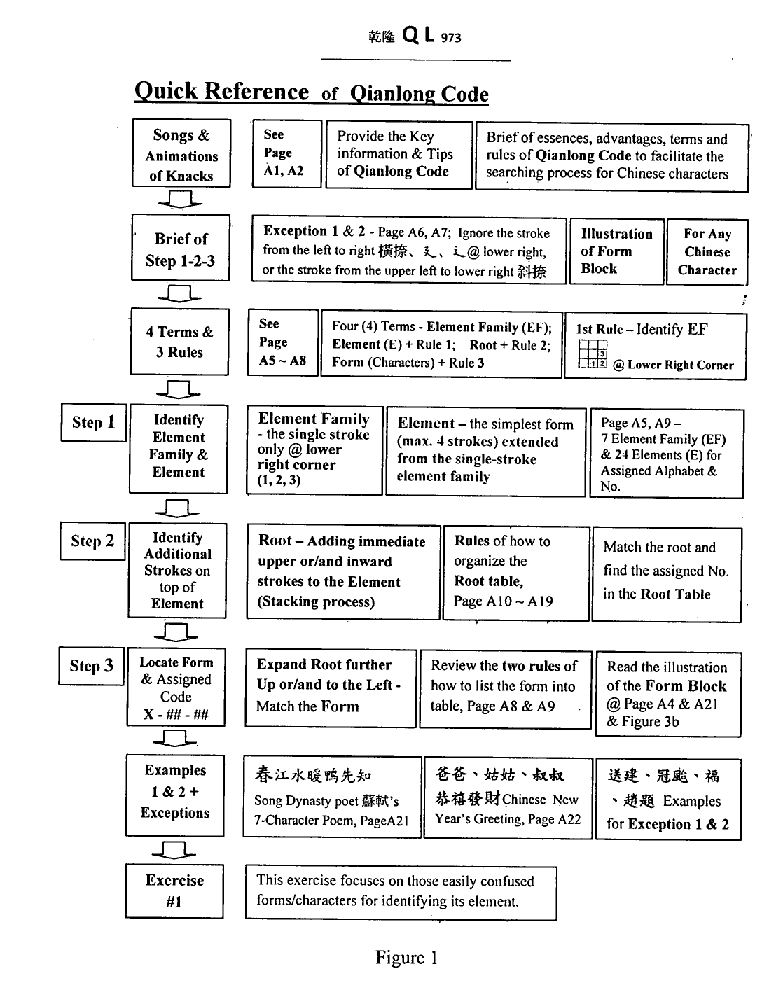

Reference is first made to FIG. 1 which consists of a flowchart generally describing the method of indexing Chinese characters in accordance with the teachings of the present invention. A more detailed explanation of the details of FIG. 1 is found in the Appendix pages A1-A26. As explained in FIG. 1, a 3×3 grid pattern is superimposed over the Chinese character that is being indexed. One concentrates on the lower right corner where boxes are numbered “1,” “2” and “3,” with the box numbered “2” being located in the lower right-hand corner of the grid.

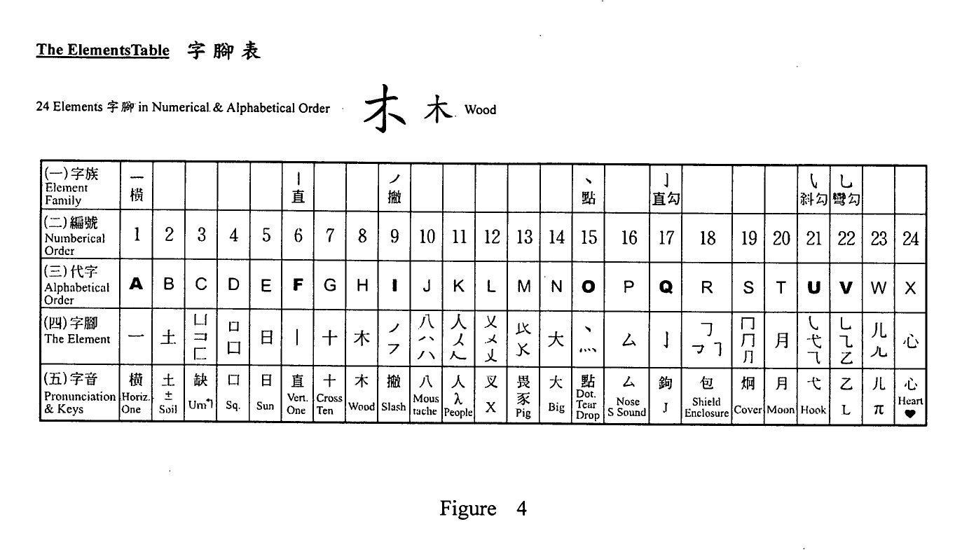

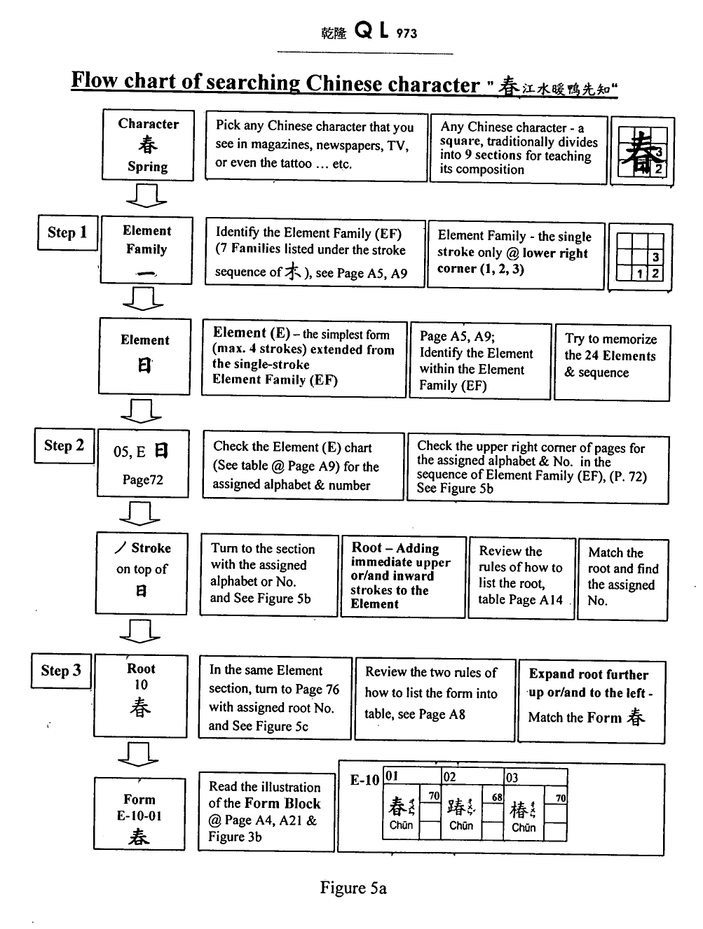

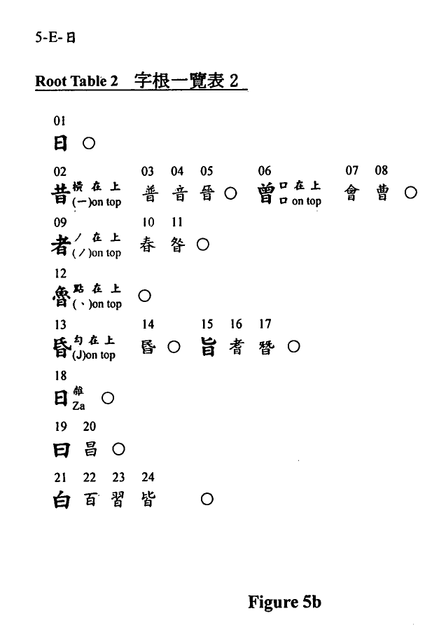

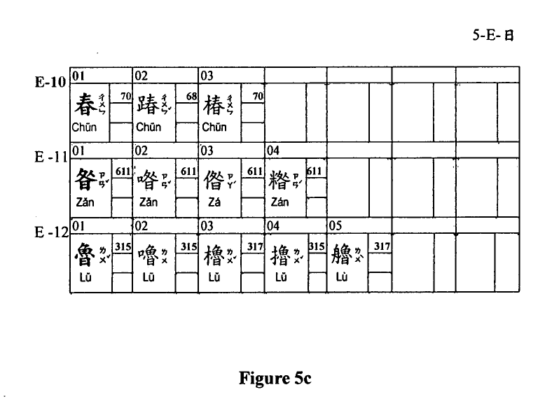

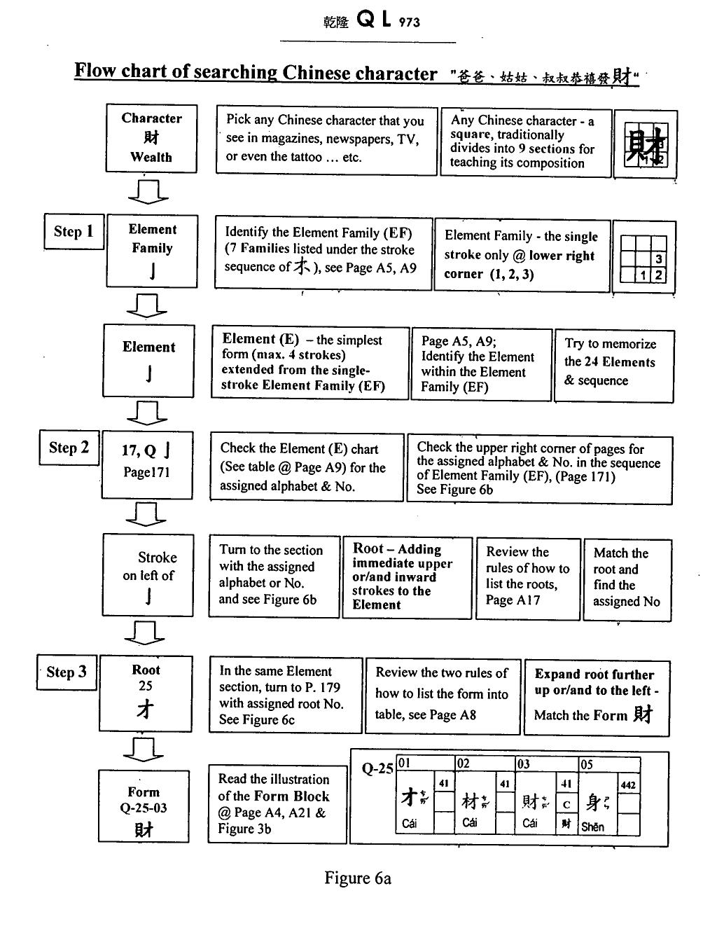

One looks at the lower right corner of the grid as superimposed over the character to determine the identification of the element family. In this regard, FIG. 3 consists of a chart identifying seven element families. Those element families are (1) horizontal, (2) vertical, (3) slash, (4) dot, and three varieties of hooks including (5) straight hook, (6) slanted hook, and (7) bent hook.

Once the element family has been identified by the shape of the lowermost stroke at the right-hand corner of the character, the next step is to identify the element. In this regard, FIG. 4 shows an element Table including twenty-four diverse elements corresponding to respective ones of the element families. Looking at FIG. 4, one may see that within the horizontal element family, there are five varieties of elements (1-5); within the vertical element family, there are three varieties of elements (6-8); within the slash element family, there are six varieties of elements (9-14); within the dot element family, there are two varieties of elements (15-16); within the straight hook family, there are four varieties of elements (17-20); within the slanted hook element family, there is one element (21); and within the bent hook element family, there are three varieties of elements (22-24).

Once the element has been identified in the elements Table of FIG. 4, the numeral (1-24) and the letter A-X corresponds to one or more pages in the index book where all of the characters corresponding to that element are located along with a Root Table corresponding to that element. The Root Table is consulted with reference to the part of the character in question immediately on top. When the correct root has been identified, reference is made in the Root Table to pages in the index corresponding to characters having the chosen root. Those pages of the index are consulted and the element and root are matched up to find the character.

Once the character has been identified, the index provides reference to a specific page in a dictionary where the user should next go to seek the same character and its definition.

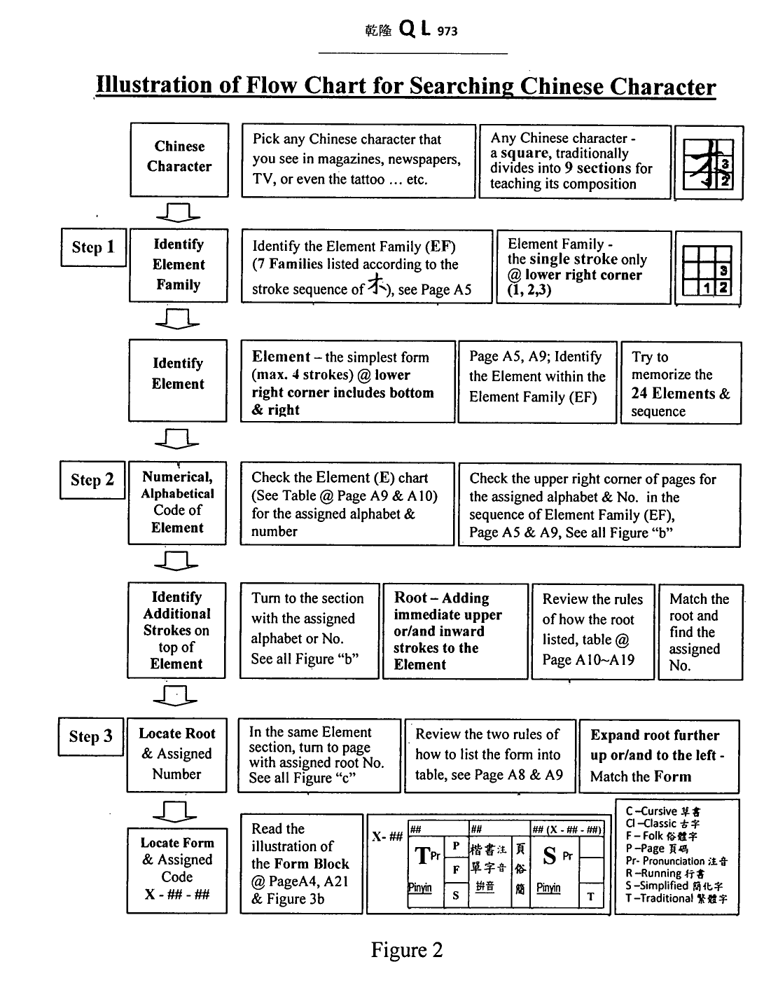

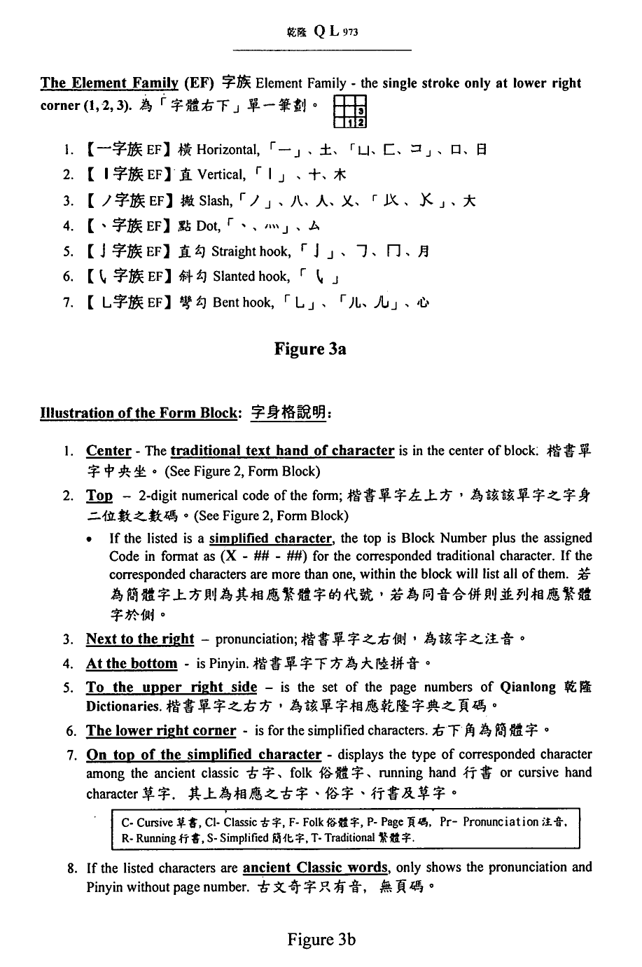

FIG. 2 shows an example of a Form Block at the bottom thereof within step 3. As seen there, the Form Block includes the character, includes a page referring to an associated dictionary where the character may be found along with its definition, the pronunciation of the character as provided as well as other pertinent information.

As explained above, the dictionary may be one that provides definitions in Chinese or may, if desired, provide translations in any non-Chinese language such as English, French, Spanish, Russian, etc.

FIG. 2 corresponds to FIG. 1 and shows the steps that would be taken to obtain the reference to a dictionary page for the particular character shown in the upper right-hand corner of FIG. 2. FIGS. 5a-10c provide examples of practicing of the inventive method for a variety of Chinese characters. Thus, with reference to FIGS. 5a, 5b and 5c, the method of finding a dictionary page for the definition of the Chinese character corresponding to the word “Spring” is shown in detail.

The character is seen in the upper right-hand corner of the flowchart of FIG. 5a. Examination of the lower right-hand corner of the character with a nine square grid superimposed thereover reveals that the lowermost stroke in the lower right-hand corner falls within the element family “horizontal.” This is confirmed with reference to FIG. 3. Then, with reference to FIG. 4, examination of the five elements 1-5 of the element family for horizontal strokes reveals that the closest element is that which is depicted by the number 5 and the letter E.

Next, the prepared index is referred to concerning all of the characters having elements corresponding to 5E in the elements Table of FIG. 4. With reference to FIG. 5b, it is seen that the character root most resembles the root 10. With reference to FIG. 5c, examination of the three choices in the line identified by E-10 reveals that the character shown in the upper right-hand corner of FIG. 5a is that which is contained within the Form Block E-10-01. In that Form Block, there is also a page number (70) that refers to a page in the dictionary to which the index is correlated. Going to that page in the dictionary reveals the same character, its definition, and examples of proper usage, either in Chinese or in any foreign language.

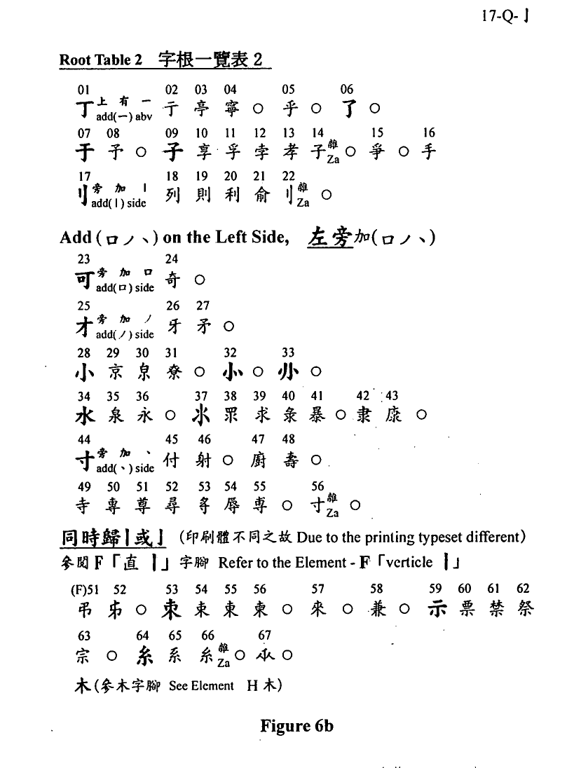

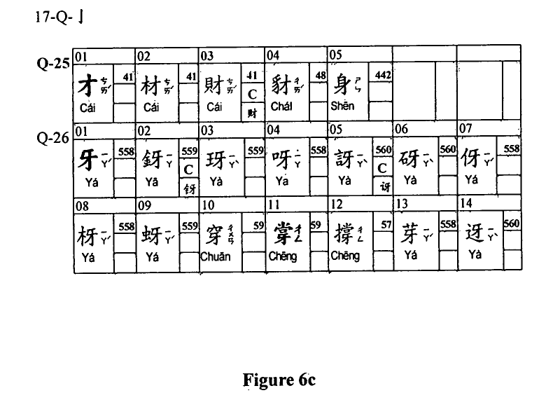

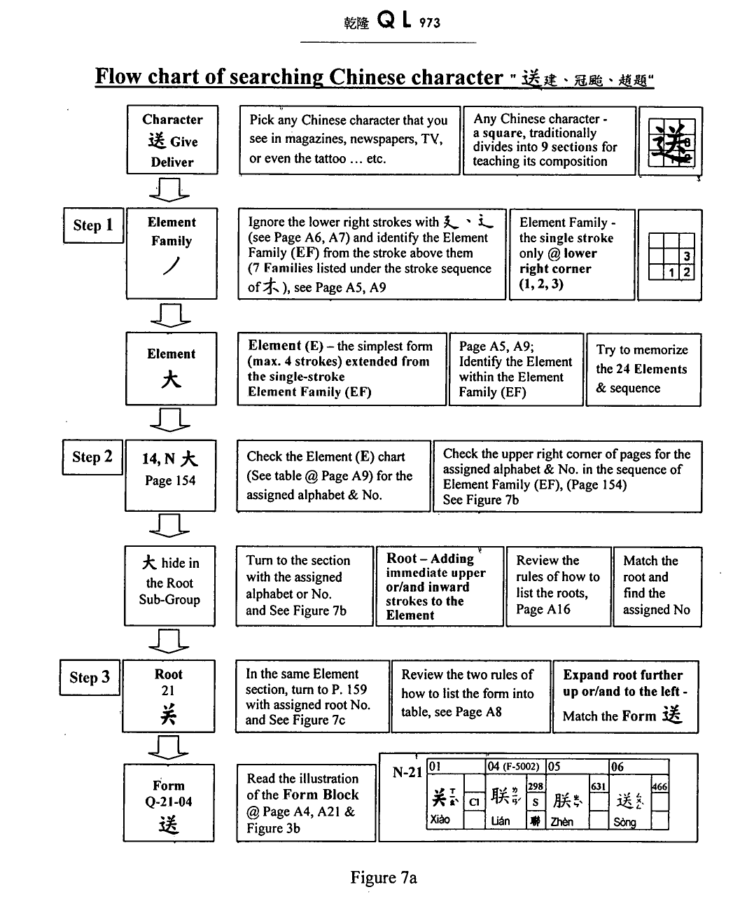

FIGS. 6a, 6b and 6c depict the method by which the dictionary page number is obtained for the Chinese character corresponding to the English word “Rich” or “Wealthy.” Again, a nine square grid is superimposed over the character and the lower right-hand corner of the character is examined to determine the correct element family with regard to FIG. 3. That element family is determined to be that of a straight hook. As seen in the upper right-hand corner of FIG. 6a, the straight hook extends down from box number 3 down to box number 2 at the lower right-hand corner of the grid. Looking at the choices in the numerical order between 17-20, it is clear that the closest approximation is that which corresponds to the number 17 and the letter Q. Next, with reference to FIG. 6b, one compares the choices in the Root Table with the part of the character in question immediately on top and determines that the root is No. 25. With this information, with reference to FIG. 6c, one examines the line identified by Q-25 and determines that the character within the Form Block labeled Q-25-03 is in direct correspondence to the character depicted in FIG. 6a. A page number (41) within that Form Block directs the user to the correct dictionary page.

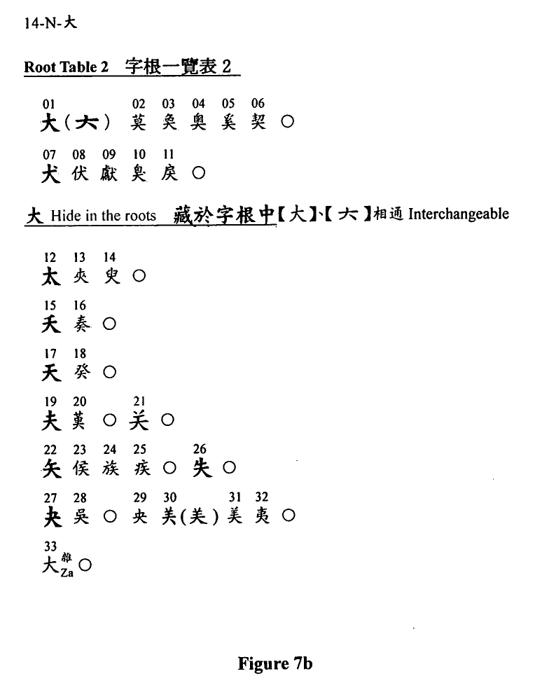

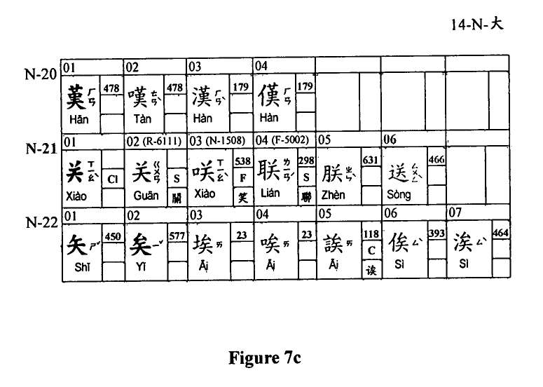

FIGS. 7a, 7b and 7c show a further example of a Chinese character corresponding to the word “Give” or “Deliver.” Again, superimposing a nine square grid over the character and examining the lower right-hand corner, one concludes that the lowermost stroke is within the slash element family including choices between varieties numbered 9-14 in FIG. 4. Further examination reveals that the closest approximation to the element is that which is depicted by the number 14 and the letter N. From the Root Table (FIG. 7b), one determines that the correct root is No. 21. Examination of the corresponding pages in the index, with reference to FIG. 7c, shows that the closest identification of the character is found in the Form Block labeled N-21-04. That Form Block includes a page 466 corresponding to a page in a dictionary where the character may be found.

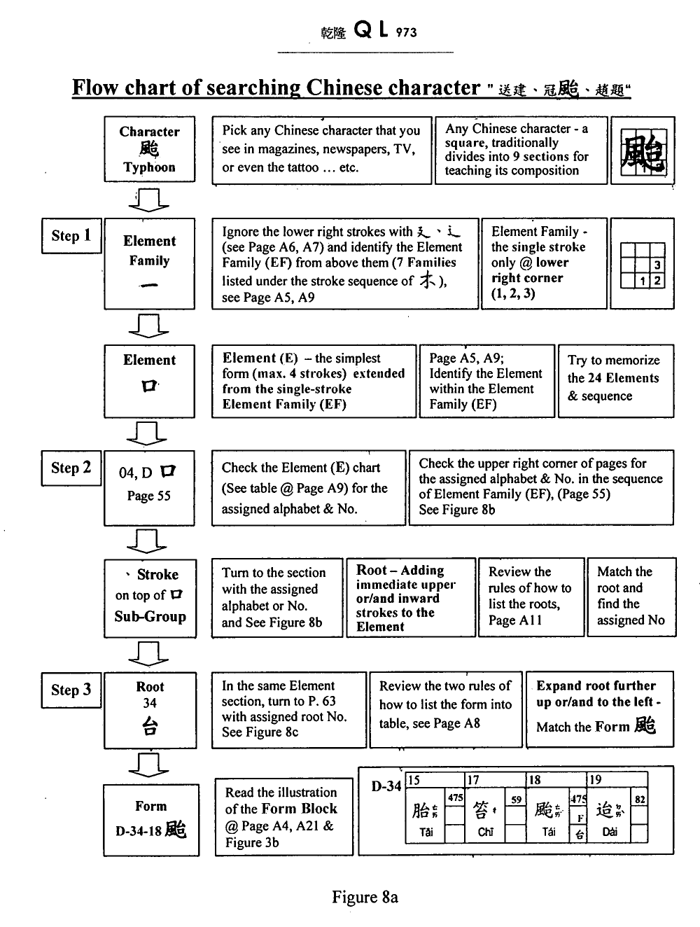

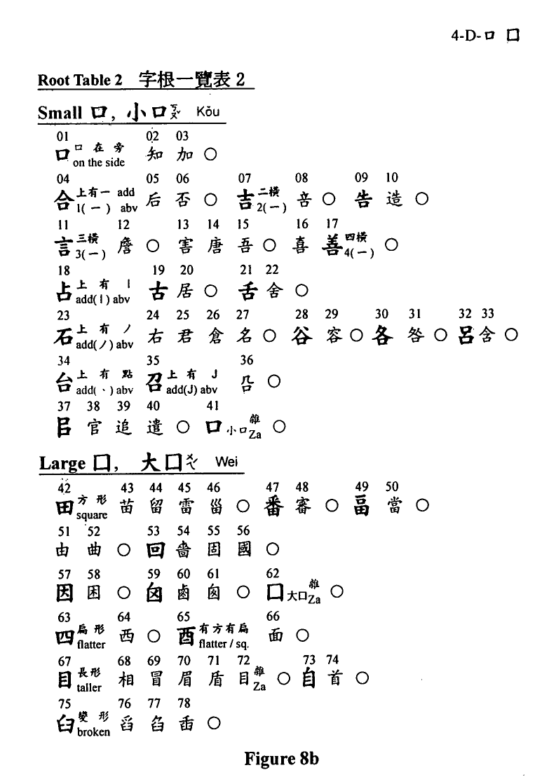

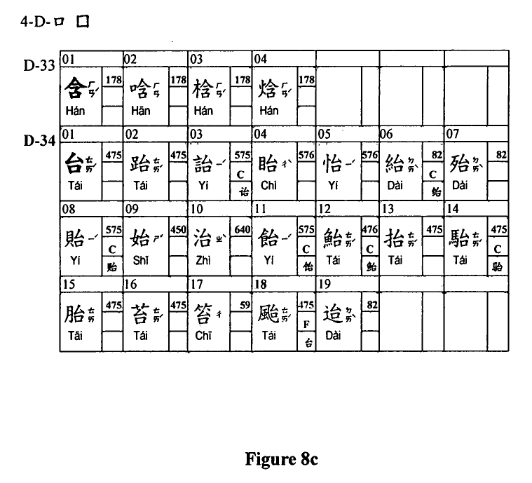

In a further example, reference is made to FIGS. 8a, 8b and 8c where the character corresponding to the word “Typhoon” is shown. Looking at the upper right-hand corner of the flowchart, and looking at the lower right-hand corner of the character, one determines that the element family is horizontal (with reference to FIG. 3) and that the element most closely resembling that which is shown in the character is that which is identified by the number 4 and the letter D. Looking at FIG. 8b, one finds that the root corresponding to D-34 most closely resembles the root of the character in FIG. 8a. Looking across and down on FIG. 8c, one finds the character in question in the Form Block corresponding to D-34-18. That Form Block includes a page number (475) directing the user to the corresponding page in a dictionary.

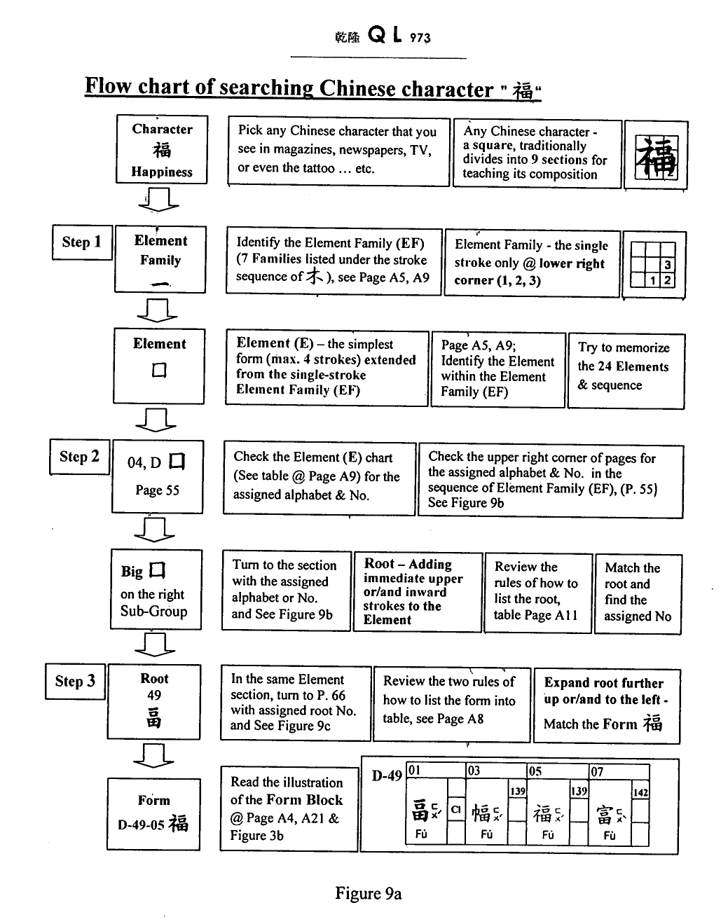

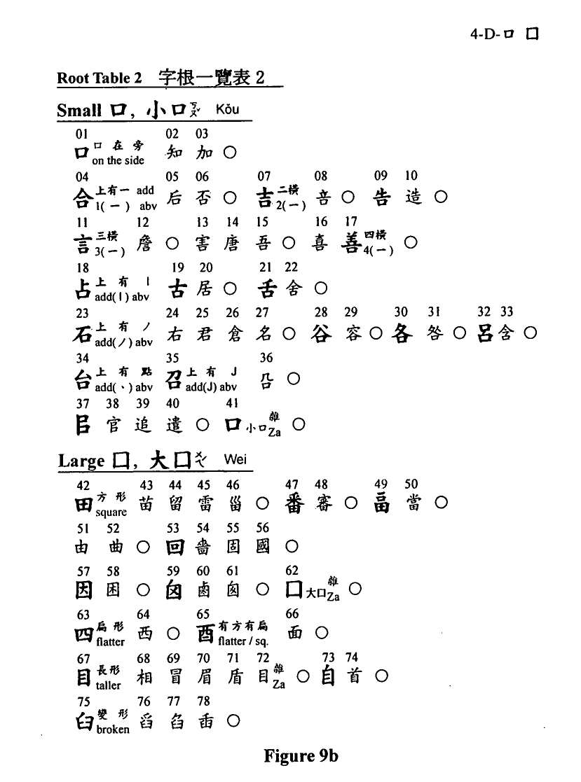

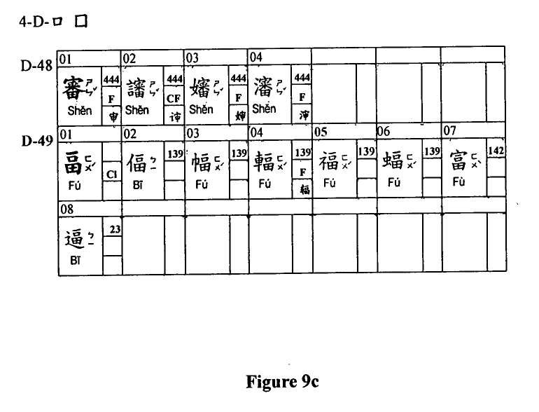

With reference to FIGS. 9a, 9b and 9c, performing the same procedure for the character corresponding to the English word “Happiness,” one identifies the element family from FIG. 3 as the slash, and with reference to FIG. 4, identifies the closest element as that which is depicted by the number 4 and the letter D. Going to FIG. 9b, the root is best identified as No. 49. Searching the 26 different characters within the D-49 section (FIG. 9c) reveals that the character identified by D-49-05 is the character in question. In that Form Block, a page number 139 for the corresponding dictionary is provided.

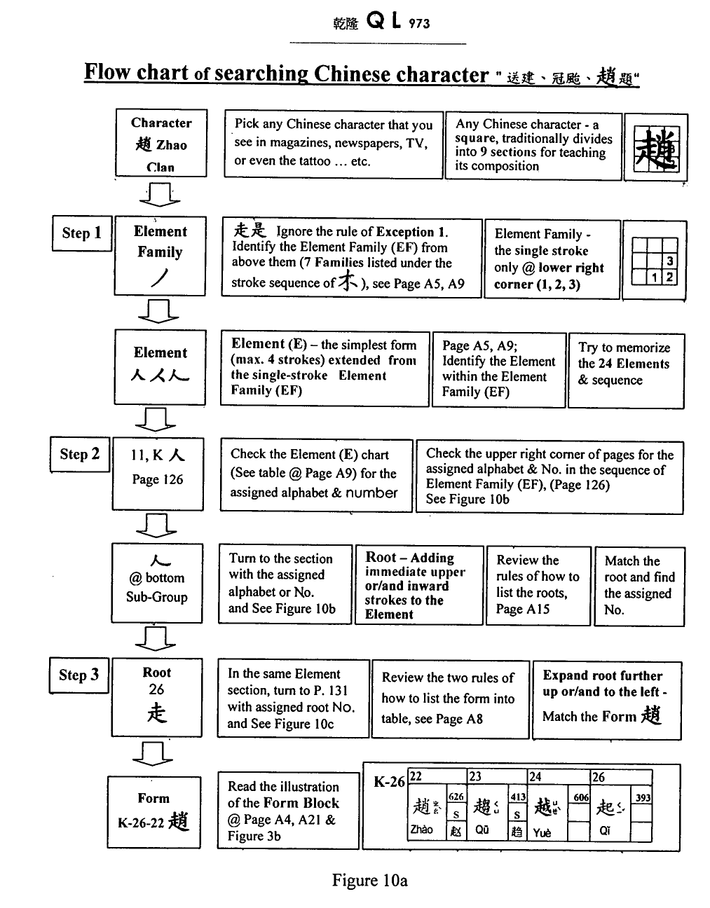

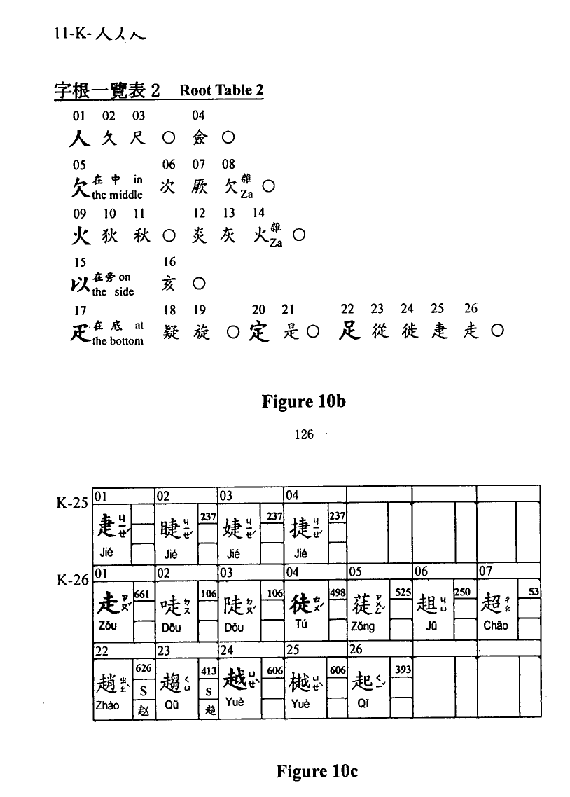

Finally, FIGS. 10a, 10b and 10c show a further example of a character corresponding to the word “Zhao clan.” Following the inventive procedure, the element family is identified from FIG. 3 as slash, and the element most closely related to the lower right-hand corner of the character is that which is described by the number 11 and the letter K. From the Root Table (FIG. 10b), the root No. 26 is identified. Looking at the section of the index (FIG. 10c), the line K-26 has fourteen different characters. Through further examination, it is clear that the character in question is number 22. On the Form Block where the character is found, a page number 626 is provided that directs the user to the appropriate page in the correlated dictionary.

As should now be clear, through creation of an index and practicing of the teachings of the present invention in conjunction with knowledge of a listing of element families and a Table of elements, the user may quickly determine a character and a page in a dictionary where the character may be found to determine its definition.

As such, an invention has been disclosed in terms of a preferred embodiment thereof which fulfills each and every one of the objects of the invention as set forth hereinabove, and provides a new and useful method of indexing Chinese characters of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. A method of indexing Chinese characters including the steps of:
a) providing an index including:
i) a table of element families;
ii) a table of elements;
iii) at least one root table; and
iv) a listing of characters having a common root;
b) providing a dictionary including definitions of Chinese characters; and
c) said listing of characters being correlated to said dictionary, whereby each character in said listing has a page number of said dictionary corresponding to a page where a said character is displayed.

2. The method of claim 1, wherein said table of element families includes seven element families.

3. The method of claim 2, wherein said seven element families include horizontal, vertical, slash, dot and three varieties of hooks.

4. The method of claim 1, wherein said table of elements includes 24 elements.

5. The method of claim 1, wherein each element within said table of elements correlates to at least one root.

6. The method of claim 5, wherein said at least one root for each element is listed on said root table.

7. The method of claim 1, wherein said listing of characters includes at least one character for each root, each character being printed within a Form Block displaying additional information pertinent to said character.

8. The method of claim 1, wherein said dictionary provides definitions of Chinese characters in Chinese language.

9. The method of claim 8, wherein said dictionary provides at least one example of proper use for each character.

10. The method of claim 1, wherein said dictionary provides definitions of Chinese characters in a language other than Chinese language.

11. The method of claim 10, wherein said language is English.

12. The method of claim 1, wherein correlation of a Chinese character to its element family is carried out by determining a shape of a lowermost stroke at a lower right-hand corner of said character.

13. The method of claim 1, wherein a character root is determined by examining a part of said character immediately on top thereof.

14. The method of claim 12, wherein a character root is determined by examining a part of said character immediately on top thereof.

15. The method of claim 14, wherein said table of elements includes 24 elements.

16. The method of claim 15, wherein said table of element families includes seven element families.

17. The method of claim 3, wherein said three varieties of hooks comprise straight, slanted and bent hooks.

18. A method of indexing Chinese characters including the steps of:
a) providing an index including:
i) a table of 7 element families;
ii) a table of 24 elements;
iii) a plurality of root tables, at least one root table for each element; and
iv) a listing of characters having a common root, each root corresponding to a plurality of characters;
b) providing a dictionary including definitions of Chinese characters; and
c) said listing of characters being correlated to said dictionary, whereby each character in said listing has a page number of said dictionary corresponding to a page where a said character is displayed, said dictionary providing a definition and at least one example of proper usage for each character.

19. The method of claim 18, wherein said seven element families include horizontal, vertical, slash, dot and three varieties of hooks.

20. The method of claim 18, wherein correlation of a Chinese character to its element family is carried out by determining a shape of a lowermost stroke at a lower right-hand corner of said character.

21. The method of claim 18, wherein a character root is determined by examining part of said character immediately on top thereof.

22. The method of claim 18, wherein each character within said listing of characters is displayed in a Form Block including pertinent information concerning each said character.

23. The method of claim 22, wherein said pertinent information includes pronunciation of said character, and proper usage of said character.
